(19) United States
(12) Patent Application Publication
(10) Pub. No.: US 2018/0094983 A1
(43) Pub. Date: Apr. 5, 2018

(54) IRT ADAPTER AND MOBILE DEVICE APPLICATION

(71) Applicant: Universal Enterprises, Inc., Beaverton, OR (US)

(72) Inventors: Sean Patrick Tierney, Milwaukie, OR (US); Michael John Kane, Portland, OR (US)

(73) Assignee: Universal Enterprises, Inc., Beaverton, OR (US)

(21) Appl. No.: 15/283,293

(22) Filed: Oct. 1, 2016

(51) Int. Cl. G01J 5/02; G01J 5/18

(52) U.S. Cl. CPC G01J 5/0265; G01J 5/18

(57) ABSTRACT

An infrared thermometer adapter for a mobile device having a housing, an aperture on the housing through which infrared radiation emitted or reflected from a target object is able to pass to an infrared sensor, an electrical plug extending rearward from the housing configured to electrically interconnect with an audio jack on the mobile device, and electronic circuitry adapted for transmitting sensor detection signals from the sensor through the mobile device audio jack so that application software downloaded and running on the mobile device is able to convert the transmitted sensor detection signals into digital data for display on the mobile device display.

### CROSS-REFERENCE TO RELATED APPLICATIONS

None.

### BACKGROUND OF THE INVENTION

The technical field of invention relates to an adapter and mobile device application for measuring temperature. More particularly, the present invention pertains to an infrared (IR) temperature sensor, or infrared thermometer (IRT), adapter and mobile device application for general non-contact measurement of temperature, the device and associated application software ideally suited for use in the heating, ventilating, and air conditioning and refrigeration (HVAC, or HVAC/R) industry.

Several different designs of temperature measurement devices have been disclosed in various publications and product offerings, and each of those described below is incorporated herein by reference. The different designs are directed to provide measurement solutions having particular advantages and disadvantages. For example, most existing non-contact thermometers are similar to the UTL IR1 infrared thermometer (IRT) by UTL, distributed by UEi. The UTL IR1 has a pistol-grip type configuration with laser target/IR measurement activating trigger, a backlit LCD screen, degrees C./degrees F. mode button, an infrared lens, and separate laser optics. The UTL IR1 instrument advertises a 10 to 1 distance to spot ratio (optical resolution), fixed emissivity (at 0.95), measurement range of 31 to 689 degrees F., and operating range of 32 to 122 degrees F. The UEi Scout I/II/III series IRT's are similar IR thermometers having distance to spot ratios ranging from 10:1 to 30:1, and use a Fresnel lens set back from the front face of the IR thermometer. As for most existing infrared thermometer devices, neither the UTL IR1 nor the UEi Scout series thermometers utilize a camera for viewing the target area to be measured, and both utilize traditional laser target means.

An example of a device that incorporates an IRT and a digital camera image is model ST-9860/9861/9862 by Standard Instruments, which combines dual laser targeting, separate image and temperature sensors, and a 2.2″ TFT color LCD display for presenting a digital camera image and numeric temperature reading. The image/camera sensor uses a separate lens and optics structure from the infrared lens and optics, and the laser optics are separate structures, one positioned above the pair of camera and IR optics and the other laser positioned below the pair of optics. The ST-9860/9861/9862 device(s) include distance to spot ratios of up to 50 to 1 (D:S 50:1), which is a relatively high optical resolution (ratio of the circular measurement spot diameter to distance to target—for example, a spot diameter of 33 mm at a distance of 130 mm gives a D:S of approximately 4:1). The dual laser targets help define the target area for thermal measurement.

A number of publications disclose various aspects of thermal imaging with a mobile device or smartphone. For example, US 2014 0200054 (application Ser. No. 13/740,261) filed Jan. 14, 2013, by Fraden discloses a protective case for a mobile device that envelopes the entire back and sides of the device and that may include sensors for external signals. U.S. Pat. No. 8,275,413 filed Nov. 22, 2011, by Fraden et al. discloses a case that envelopes a mobile device, and U.S. Pat. No. 8,825,112 filed Feb. 26, 2014, by Fraden et al. discloses a mobile device with integral electromagnetic radiation sensors; and both of these specifically emphasize the combined use of the IR and photo sensors as key components of the designs.

A couple of existing products comprise an attachment to a mobile device that provide thermal imaging capabilities. The FLIR One is advertised as a “thermal imaging camera attachment” that connects to an Apple lightning port (used on iPhone 5 and 6 IOS smartphones, for example) or a mini-USB port (for example, with Android phones) that provides non-contact temperature measurement of any spot in a scene between −4 degrees F. and 248 degrees F. The FLIR One attachment features a thermal camera with its optics directed similar to the IOS or Android phone backside camera optics, i.e. away from the front display in a direction perpendicular to the plane defined by the length and width dimensions of the phone/mobile device (or away from the front display in a direction parallel to the thickness dimension of the phone/mobile device).

Another attachment that connects to a mobile device and incorporates thermal camera optics similar to the FLIR One is an attachment from Seek Thermal, which is priced the same as the FLIR One, at $249, and is available for IOS and Android smartphones to, as Seek Thermal advertises, “turn your smartphone into a thermal imager.” The Seek Thermal attachment connects via the lightning or min-USB port and includes thermal camera optics directed the same as the phone's backside camera, in a direction away from the front display and parallel to the thickness dimension of the phone.

Each of the existing temperature measurement device designs has disadvantages in terms of cost, complexity of design, ease of use, range of IR energy detected, method of measurement data collection, method for providing alerts or alarms, form factor and ergonomics of the device, design aesthetics, and/or other factors. What is needed are designs for an infrared thermometer attachment for a mobile device that address one or more disadvantage of existing designs.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 illustrates a user's hand holding a mobile device with an IRT attachment and running application software for operating the attachment, according to preferred embodiments.

FIG. 2 illustrates an infrared thermometer sensor audio jack adapter, according to preferred embodiments.

FIG. 3 illustrates a block diagram for operation of an IRT attachment and mobile device with application software, according to preferred embodiments.

FIGS. 4A and 4B comprise schematics of exemplary circuitry comprising the attachment of FIG. 2, according to various embodiments.

### DETAILED DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

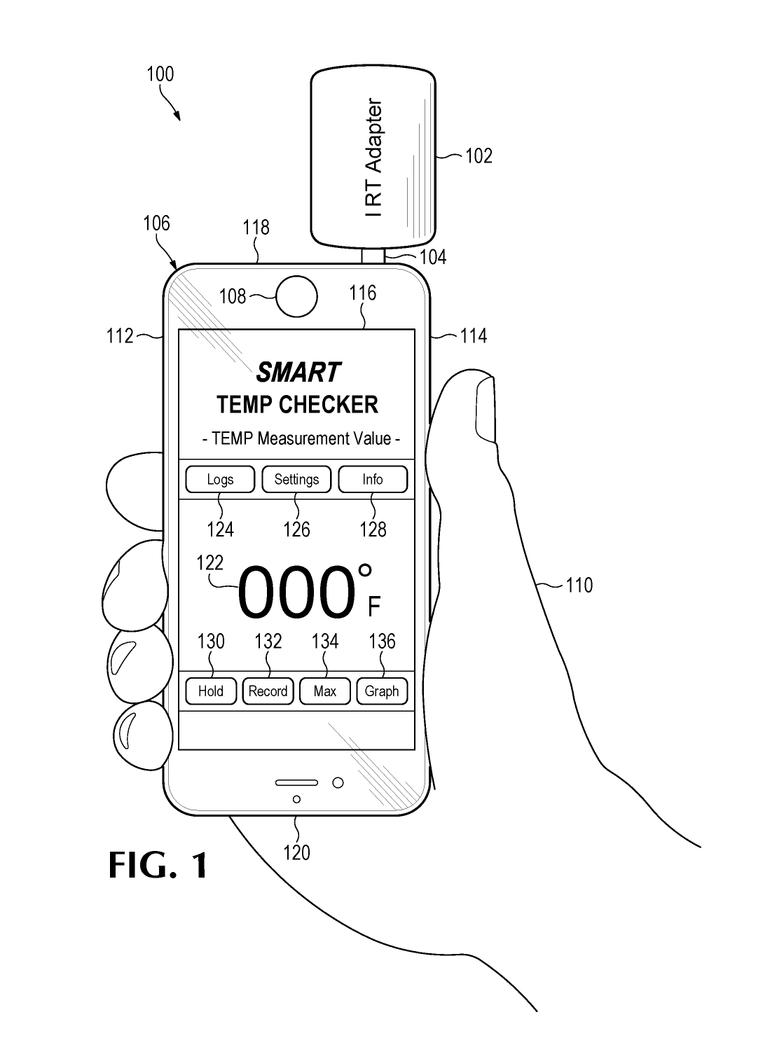

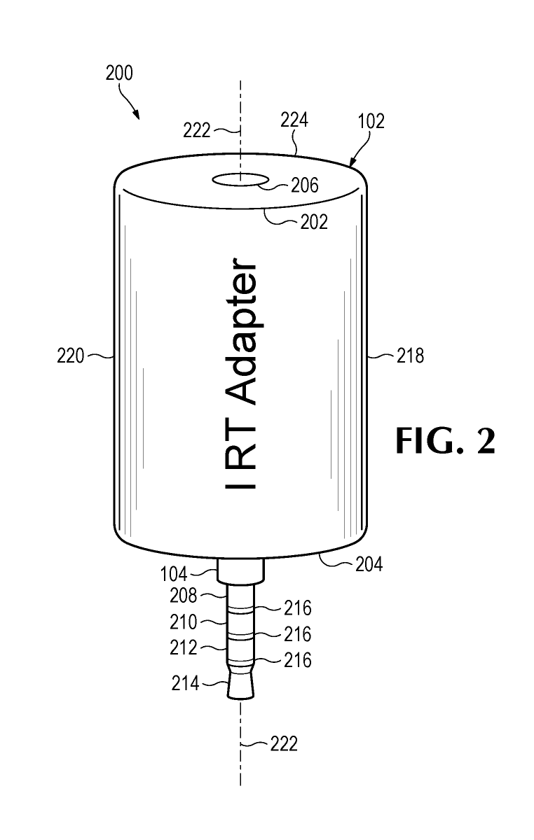

Preferred embodiments comprise: a mobile communications device, or smartphone, attachment having infrared temperature sensor means, circuitry for receiving power from the mobile device, circuitry for providing sensor signals to the mobile device, and the attachment connected to the mobile device via the mobile device audio jack (socket), or, alternatively, the mobile device charging/data port such as the mini-USB port for Android or similar devices or lightning charging/data port for IOS devices; and mobile device application software downloaded onto the mobile device and adapted to allow a user of the mobile device with infrared temperature sensor attachment to display, store, retrieve, graph, and manipulate temperature measurement data. A preferred embodiment is shown in FIGS. 1 and 2, with FIG. 1 showing an IRT attachment 102 connected to the mobile device 106 audio jack and oriented so as to point the IRT attachment 102 toward a target object for temperature measurement, and FIG. 2 showing the IRT attachment 102 having an outward facing infrared lens/port 206 and an inwardly extending electrical interface plug 104 for connecting into the audio jack of the mobile device 106. As will be discussed further, alternative embodiments may implement the IRT attachment 102 using different shapes/dimensions for the housing or, for example, orienting the IR lens/port 206 differently (such as pointing the lens/port 206 in the same direction as the camera optics on the mobile device 106 instead of, as shown and preferred, pointing the lens/port 206 outward away from the mobile device in a direction along the axis of the plug 104).

FIG. 1 illustrates a preferred orientation 100 with a user's hand 110 holding the mobile device 106 with an IRT attachment 102 connected via the attachment plug 104 and the device audio jack, and running application software downloaded to the mobile device for operating the attachment. The attachment 102 is shown with a plug 104 inserted into the audio jack of the mobile device 106. The mobile device 106 shown is an iPhone 5 style smartphone with its main front face button 108 oriented so that the audio jack and plug 104 axis is directed outward away from the user's hand 110 toward a target object for temperature measurement. If the mobile device 106 were illustrated as an iPhone 4 style smartphone, the main button 108 would be oriented at the opposite end of the display 116, with the audio jack on the far end 118 of the device 106 and the button 108 nearest the near end 120 of the device 106, closer to the palm of the user's hand 110.

The mobile device 106 is shown having a length dimension between a near end 120 and a far end 118, and a width dimension between a left side 112 and a right side 114. A thickness dimension, not shown, is the distance between the front of the phone/front of display 116 and the backside of the phone. The thickness dimension is perpendicular to the plane formed by the length and width dimensions. The main camera optics of an iPhone 5 are on the backside of the phone and are directed away from the front face of the display 116 and in a direction parallel with the thickness dimension of the phone (and perpendicular to the plane defined by the length and width dimensions).

Preferably, the user holds the mobile device 106 as shown in FIG. 1, and points the outward end of the IRT attachment 102 so that the target object to be measured is along a line of sight that extends along the lengthwise dimension of the mobile device 106. The user preferably opens an app downloaded onto the mobile device for operating the IRT attachment 102. Using the touch screen/display 116, the user is preferably presented with simple options for operating the attachment 102. For example, and as shown, opening the (“Temp Checker) app presents the user with several buttons, including “Logs” 124, “Settings” 126, “Info” 128, “Hold” 130, “Record” 132, “Max” 134, and “Graph” 136. Once the app opens and establishes communications with the attachment 102, real time measurement information 122 is preferably displayed. If the real time measurement information 122 is, for example, 67 degrees F., then the measurement information 122 reads “67 degrees F”. As the user moves to point the attachment 102 to another target, the measurement information 122 changes to display the sensed and calculated temperature measurement for the new target object.

The app software buttons shown on display 116 in FIG. 1 preferably comprise buttons on the app main screen, and the buttons are preferably customizable by the user when downloading and initially setting up the app and during subsequent use of the app. Each button preferably provides the user with quick access to a particular app function. Selecting “Logs” 124 preferably causes retrieval and display of previously recorded temperature measurements. “Settings” 126 preferably provides the user with display options such as measurements in degrees F. or degrees C., display font size, background display options, information to include with recorded measurements (such as date formats, location information, client/job information, etc.), and other options; and the available settings preferably includes options for the user to customize the buttons displayed on display 116. For example, a “Min” button might be available if the user would like to keep track of minimum measurement values and have the “Min” button added (i.e. pinned) to the app main display screen. Further, the “Settings” 126 button preferably provides, when selected, listed options that the user may scroll through using standard finger swipe motions on touch screen/display 116. “Info” 128 may provide information about the amount of data saved, remaining memory available, software version information, etc. “Hold” 130 preferably retains the presently displayed measurement information on the display 116. “Record” 132 preferably saves the measurement or series of measurements into memory. “Max” 134 preferably presents the highest measurement value for a particular series of measurements. And “Graph” preferably presents a series of measurements graphically on display 116.

FIG. 2 illustrates an infrared thermometer (IRT) sensor audio jack adapter 200, according to preferred embodiments. The IRT adapter 200 preferably comprises attachment 102 having a (housing) length dimension between an outward most end (or outward face) 202 and a near/rear end 204, and a width dimension between a left side 220 and a right side 218. A thickness dimension is the distance between the front of the housing 202 and the backside of the housing 224. The thickness dimension is perpendicular to the plane formed by the length and width dimensions. Preferably, the length of the attachment 102 is greater than its width, and the length of the attachment 102 is greater than its thickness. Preferably, the dimensions of the attachment 102 are as small as possible. The length of the attachment 102 is preferably less than the length of the mobile device 106, and is preferably less than the width of the mobile device 106. The width of the attachment 102 is preferably less than the width of the mobile device 106, and is preferably (considerably) less than the length of the mobile device 106. Preferably, just as the length of the mobile device is (preferably) greater than either of its width or thickness dimensions, the length of the attachment 102 is greater than either of its width or thickness dimensions.

In one embodiment, the housing portion of attachment 102 comprises a rectangular prism with a cross-sectional area (defined by its width and thickness) along its full length from outward face 202 to its near end 204. In one embodiment, the housing width and thickness dimensions are approximately equal. In a preferred embodiment, the housing is a rectangular prism with rounded sides such that the front and back sides have flattened areas and the sides are more rounded. The resulting rounded rectangular prism preferably has a width dimension slightly greater than its thickness, due to the flattened front and back areas. In other alternative embodiments, the attachment 102 housing comprises a nearly cylindrical shape. In the embodiment shown in FIGS. 1 and 2, attachment 102 housing comprises an oval prism shape, with a cross-section having rounded left and right sides separated by a flat front and back sides, the cross-section extending outward from a near end 204 to an outward face 202.

The IRT adapter 200 preferably includes an IR lens/port (or aperture) 206 substantially centered about a lengthwise longitudinal axis 222 that extends along the plug 104, through the length of the attachment 102, and outward from the IR lens/port 206 to a target object for temperature measurement. The present inventors determined such orientation of the IR lens/port 206 provides improved ease of use in measuring temperature in HVAC and other environments. The user is able to point to the target object in a natural hand motion when holding the mobile device 106 so that the IR lens/port 206 is pointing along the longest dimension of the combined IRT adapter connected to the mobile phone, i.e. the preferred orientation 100 as illustrated in FIG. 1. The present inventors determined a lengthwise longitudinal line of sight axis 222 running parallel to the length dimension of the mobile device 106 and through the centerline of the IRT adapter 200 is most preferred for improved stability and accuracy, natural ergonomics of using the IRT adapter 200, and simplicity of design and use over other temperature measurement devices, none of which are similarly configured as shown in FIGS. 1 and 2.

The IR lens/port 206, in less preferred embodiments, may be oriented off-center on the outward most end 202. And the IR lens/port 206, in alternate embodiments, may be oriented elsewhere on the attachment 102 housing, rather than on the outward face 202, in which case the IR sensor line of sight would no longer be along the lengthwise longitudinal axis 222. For example, if the IR lens/port 206 is oriented on a side of the attachment 102 housing so as to point in the same direction as the mobile device 106 main camera, the IR line of sight would be aligned with the mobile device 106 main camera.

Extending rearward from the attachment 102 housing is, as shown in FIG. 2, an electrical interface plug 104 having dimensional characteristics to electrically and structurally cooperatively insertingly mate into the audio jack of a mobile device 106. The plug 104 preferably comprises electrical conductors 208, 210, 212, and 214, each separated by an electrical insulator 216. A standard audio jack typically includes electrical conductor configured for receiving the corresponding conductors on plug 104, with plug conductor 208 corresponding to an audio jack conductor for the mobile device microphone or MIC; plug conductor 210 corresponding to an audio jack conductor for ground; plug conductor 212 corresponding to an audio jack conductor for right audio channel signal; and plug conductor 214 corresponding to an audio jack conductor for left audio channel signal. The electrical conductors 208, 210, 212, and 214 are available for use by the mobile device application software and circuitry comprising the attachment 102 for providing power to the attachment 102 circuitry therein, and for transferring data and sensor signals for operation of the attachment 102.

In other preferred embodiments, not shown, the plug 104 may instead comprise a male connector for use with an IOS lightning charger/data port or an Android mini-USB, or any other electrical interface with a mobile device 106. The available conductors on IOS lightning, mini-USB, or similar connectors may be used in similar fashion as the electrical conductors 208, 210, 212, and 214 shown in FIG. 2 with sensor circuitry and supporting signal processing circuitry comprising attachment 102.

In preferred embodiments, the attachment 102 has no battery and is powered by the mobile device via electrical conductors such as electrical conductors 208, 210, 212, and 214. In other embodiments, the attachment 102 includes a battery, such as a 3V battery.

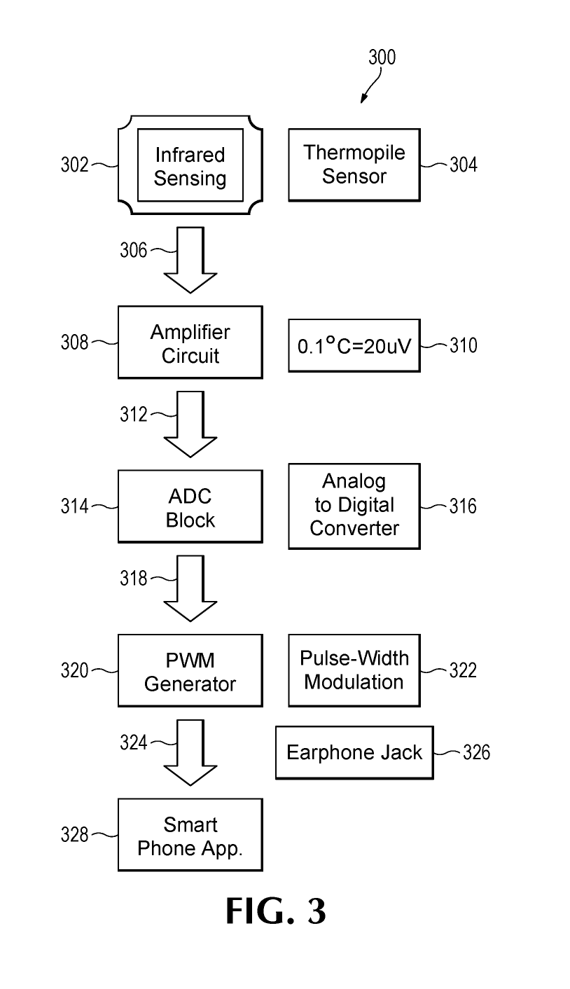

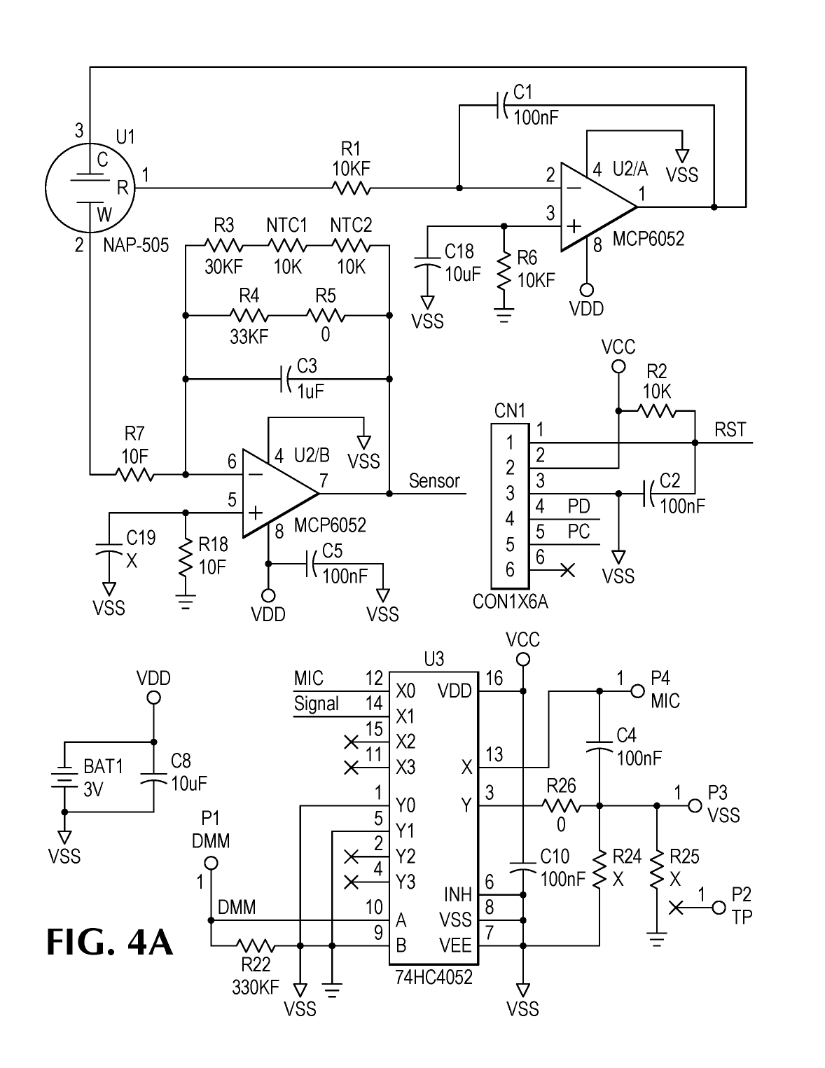

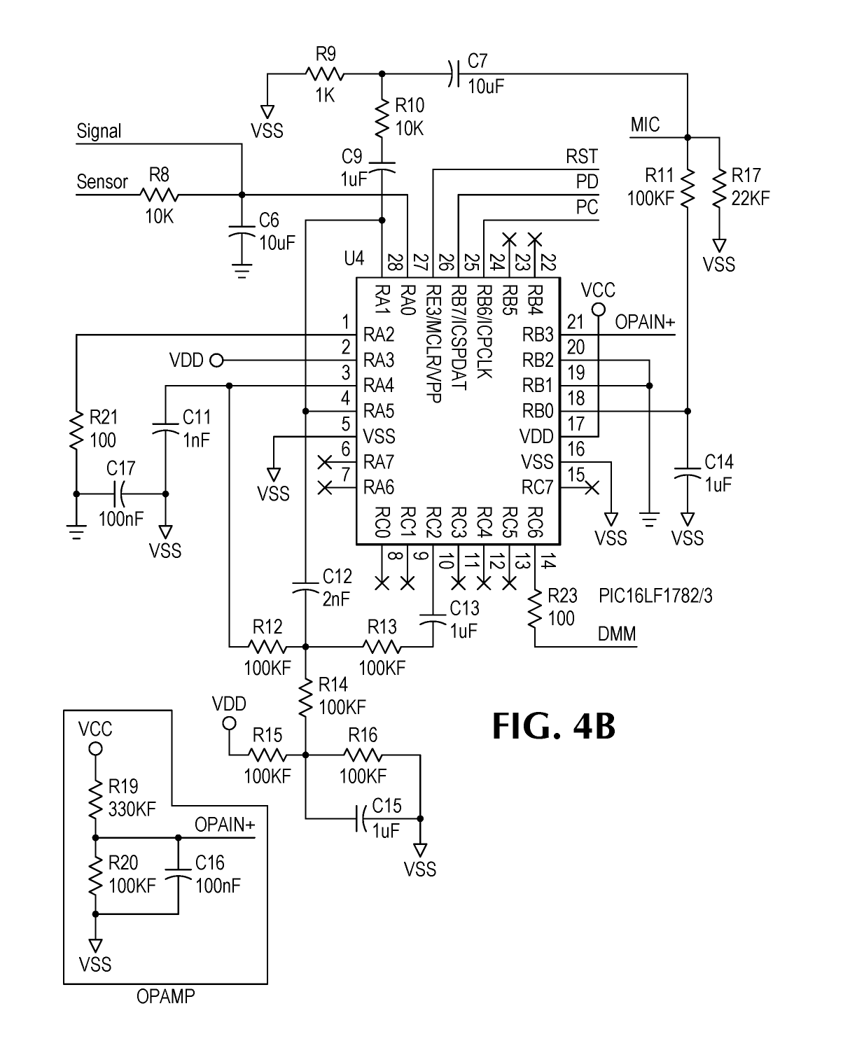

FIGS. 3, 4A and 4B provide exemplary implementation of the IRT adapter 200 and mobile device application for the preferred orientation 100 as illustrated in FIGS. 1 and 2. FIG. 3 illustrates a block diagram 300 for operation of an IRT attachment and mobile device with application software, according to preferred embodiments, and FIGS. 4A and 4B comprise schematics of exemplary circuitry comprising the attachment of FIG. 2, according to various embodiments. In one embodiment, in an infrared sensing step 302, a thermopile type infrared sensor 304 detects the reflected infrared radiation energy emitted or reflected from a target object. The detected signals are then sent 306 to an amplifier circuit 308 for amplification. Each 0.1 degree C. is 20 microvolts in detected signal strength. The amplified detected signal is then sent 312 to an analog-to-digital converter (ADC) block 314 of a microcontroller (MCU). The analog signals measured by the ADC block 314 are converted to a digital signal 316, and then the digital signal/data is sent 318 to a pulse-width modulation (PWM) generator 320. The PWM generator 320 converts the digital data to audio signals which are received 324 through the audio (or earphone) jack 326. Finally, the audio signals received through the earphone jack 326 are converted to digital data by the app program 328 for display (of the temperature measurement data) on the smartphone/mobile device.

The application software preferably comprises a mobile device app for use with the infrared thermometer adapter that includes programming instructions downloadable for storage and execution on the mobile device 106 and adapted to transform sensor detection signals received through the audio jack of said mobile device from pulse-width modulation signals generated by circuitry of the infrared thermometer adapter 102 to digital data for display of temperature measurement information on the display screen 116 of the mobile device 106. The programming instructions preferably enable use of the mobile device touch screen for receiving user selection (eg. by touching a virtual button displayed on the touch screen) of user-selectable and user-customizable options for such things as visual display preferences (eg. temperature in degrees F. or degrees C.), whether to initiate or stop recording temperature measurements, and to toggle on and off display of graphed temperature measurements.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An infrared thermometer adapter for a mobile device comprising:
a housing having a length between an outward face of said housing and a near end of said housing;
an aperture on the outward face of the housing, through which infrared radiation emitted or reflected from a target object is able to pass to an infrared sensor within said housing;
an electrical plug extending rearward from the near end of the housing, the electrical plug configured to electrically interconnect with an audio jack on said mobile device; and
circuitry adapted for transmitting sensor detection signals from said infrared sensor through said audio jack on said mobile device so that application software running on said mobile device is able to convert the transmitted sensor detection signals into digital data for display on said mobile device.

2. The adapter of claim 1 wherein said infrared sensor is a thermopile type infrared sensor.

3. The adapter of claim 2 wherein said circuitry comprises amplifier circuitry to amplify output from said infrared sensor.

4. The adapter of claim 3 wherein said circuitry comprises an analog-to-digital converter to convert amplified output from said infrared sensor to digital data.

5. The adapter of claim 4 wherein said circuitry comprises a pulse-width modulation generator to convert said digital data to audio jack signals for sending sensor detection signals to said mobile device via said electrical plug.

6. A mobile device application for use with an infrared thermometer adapter comprising programming instructions downloadable for storage and execution on said mobile device and adapted to transform sensor detection signals received through an audio jack of said mobile device from pulse-width modulation signals generated by circuitry of said infrared thermometer adapter to digital data for display of temperature measurement information on a display screen of said mobile device.

7. The application of claim 6, wherein said programming instructions enable touch screen means for user selection of options for visual display, recording, and graphing said temperature measurement information.

8. The application of claim 7, wherein said user selection is made by touching a button presented on said touch screen.

9. The application of claim 1, wherein said mobile device comprises an IOS or Android type smartphone.

10. A method of measuring the temperature of a target object comprising:
providing an infrared thermometer adapter for a mobile device including a housing having a length between an outward face of said housing and a near end of said housing, an aperture on the outward face of the housing through which infrared radiation emitted or reflected from a target object is able to pass to an infrared sensor within said housing, an electrical plug extending rearward from the near end of the housing and configured to electrically interconnect with an audio jack on said mobile device, and circuitry adapted for transmitting sensor detection signals from said infrared sensor through said audio jack on said mobile device so that application software running on said mobile device is able to convert the transmitted sensor detection signals into digital data for display on said mobile device;
providing a mobile device having an audio jack;
downloading said application software to said mobile device;
plugging the electrical plug of the infrared thermometer adapter into the audio jack of the mobile device; and
running said application software on said mobile device.

11. The method of claim 10 further comprising:
sensing infrared radiation emitted or reflected from a target object using an infrared sensor in said infrared thermometer adapter;
amplifying detection signals from said infrared sensor;
converting the amplified detection signals to digital signals;
converting the digital signals to pulse-width modulated audio signals;
transmitting the pulse-width modulated audio signals to mobile device via the electrical plug of the infrared thermometer adapter and the mobile device audio jack; and
displaying the temperature measurement using said downloaded and running application software.

12. The method of claim 10 wherein said mobile device comprises an IOS or Android type smartphone.
